(19) United States
(12) Patent Application Publication
(10) Pub. No.: US 2026/0003414 A1
(43) Pub. Date: Jan. 1, 2026

(54) ELECTRIC POWER UTILIZATION ABNORMALITY MONITORING METHOD AND SYSTEM

(71) Applicant: ASUSTeK COMPUTER INC., Taipei City (TW)

(72) Inventors: Tzu-Hung Chuang, Taipei City (TW); Shih-Chieh Liao, Taipei City (TW); Chin-Hao Chang, Taipei City (TW); Shih-Chuan Chiu, Taipei City (TW); Chia-Hao Kang, Taipei City (TW); Yi-Nan Lee, Taipei City (TW); Wei-Cheng Chen, Taipei City (TW)

(73) Assignee: ASUSTeK COMPUTER INC., Taipei City (TW)

(21) Appl. No.: 19/046,524

(22) Filed: Feb. 6, 2025

(30) Foreign Application Priority Data
Jun. 26, 2024 (TW) 113123769

(51) Int. Cl. G06F 1/3206

(52) U.S. Cl. CPC G06F 1/3206

(57) ABSTRACT

An electric power utilization abnormality monitoring method and system are provided. The method includes the following steps: periodically collecting power consumption data of each of a plurality of mobile devices, wherein the power consumption data includes a plurality of applications executed by the mobile devices during a non-charging period and a corresponding battery power consumption thereof; calculating and recording a daily average unit time electric power utilization of each of the applications according to the power consumption data of each of the mobile devices; analyzing the daily average unit time electric power utilization of each of the applications during a monitoring period to determine whether there are any abnormal applications having an electric power utilization abnormality in the applications on a current day; and providing corresponding abnormality information to the mobile devices on which the abnormal application is installed when the abnormal application exists.

### CROSS-REFERENCE TO RELATED APPLICATION

This application claims the priority benefit of Taiwan application serial no. 113123769, filed on Jun. 26, 2024. The entirety of the above-mentioned patent application is hereby incorporated by reference herein and made a part of this specification.

### BACKGROUND OF THE INVENTION

### Field of the Invention

The invention relates to an electric power utilization abnormality monitoring method and system for an application (APP) executed on a mobile device.

### Description of Related Art

After updating the version of an application (APP) installed on a mobile device, there may be new functional designs or unexpected program errors (bugs) in the updated version, which may readily cause electric power utilization abnormality. Therefore, how to enable the user to detect electric power utilization abnormality as early as possible and adopt a corresponding power-saving strategy has become an increasingly important issue in the art.

### SUMMARY OF THE INVENTION

The present application provides an electric power utilization abnormality monitoring method. The method includes the following steps: periodically collecting power consumption data of each of a plurality of mobile devices, wherein the power consumption data includes a plurality of applications executed by the mobile devices during a non-charging period and a corresponding battery power consumption thereof; calculating and recording a daily average unit time electric power utilization of each of the applications according to the power consumption data of each of the mobile devices; analyzing the daily average unit time electric power utilization of each of the applications during a monitoring period to determine whether there are any abnormal applications having an electric power utilization abnormality in the applications on a current day; and providing corresponding abnormality information to the mobile devices on which the abnormal application is installed when the abnormal application exists.

The present application also provides an electric power utilization abnormality monitoring system including a plurality of mobile devices and an electronic device. The electronic device includes a connection device, a memory, and a processor. The connection device is configured to be connected to the mobile devices. The memory is configured to store data. The processor is coupled to the connection device and the memory, and is configured to: periodically collect power consumption data of each of the mobile devices via the connection device, wherein the power consumption data includes a plurality of applications executed by the mobile devices during a non-charging period and a corresponding battery power consumption thereof; calculate and record a daily average unit time electric power utilization of each of the applications according to the power consumption data of each of the mobile devices; analyze the daily average unit time electric power utilization of each of the applications during a monitoring period to determine whether there are any abnormal applications having an electric power utilization abnormality in the applications on a current day; and provide corresponding abnormality information to the mobile devices on which the abnormal application is installed via the connection device when the abnormal application exists.

Based on the above, the electric power utilization abnormality monitoring method and system of the present application may analyze the power consumption data of the applications uploaded by each of the mobile devices to accurately detect the application and the version thereof causing electric power utilization abnormality on the current day. In this way, the user may detect the electric power utilization abnormality as early as possible and adopt a corresponding power-saving strategy, and the power-saving strategy may be made more accurate and flexible.

In order to make the aforementioned features and advantages of the present application more comprehensible, embodiments accompanied with figures are described in detail below.

### BRIEF DESCRIPTION OF THE DRAWINGS

FIG. 1 is a block diagram of an electric power utilization abnormality monitoring system shown according to an embodiment of the invention.

FIG. 2 is a flowchart of an electric power utilization abnormality monitoring method shown according to an embodiment of the invention.

FIG. 3 is a flowchart of an electric power utilization abnormality monitoring method shown according to an embodiment of the invention.

FIG. 4A and FIG. 4B are examples of graphs of average unit time electric power utilization shown according to an embodiment of the invention.

### DESCRIPTION OF THE EMBODIMENTS

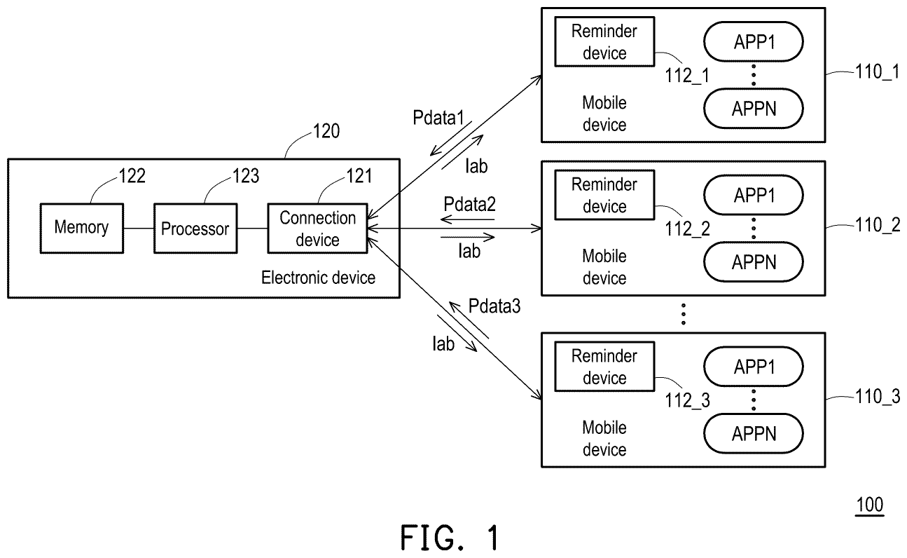

Referring to FIG. 1, an electric power utilization abnormality monitoring system 100 of the present embodiment includes mobile devices 110_1 to 110_3 and an electronic device 120. The mobile devices 110_1 to 110_3 may be, for example, mobile electronic devices that may be readily carried by a user such as smart phones, personal digital assistants (PDAs), personal digital assistant cell phones, or tablet computers. The electronic device 120 may be, for example, a computer device capable of collecting, classifying, analyzing, and storing big data such as a server, a desktop computer, or a notebook computer. As shown in FIG. 1, the electronic device 120 includes a connection device 121, a memory 122, and a processor 123, the functions of which are described below.

The connection device 121 is, for example, a combination of a network card and an antenna. For example, the network card may support wireless network cards of various wireless communication standards such as Bluetooth low energy (BLE), WiFi (Wireless Fidelity) communication protocol, and WiFi Direct. The connection device 121 may be used for wireless connection with the mobile devices 110_1 to 110_3.

The memory 122 is used to store various data uploaded by the mobile devices 110_1 to 110_3 and program codes executing various algorithms. The memory 122 may be, for example, any type of fixed or removable random-access memory (RAM), read-only memory (ROM), flash memory, hard disk, or other similar devices, integrated circuits, and a combination thereof.

The processor 123 is, for example, a central processing unit (CPU) or a programmable microprocessor, digital signal processor (DSP), programmable controller, application-specific integrated circuit (ASIC), or other similar devices or a combination thereof for general use or special use. As shown in FIG. 1, the processor 123 is coupled to the connection device 121 and the memory 122. In the present embodiment, the processor 123 may, for example, load the corresponding program code from the memory 122 to execute the electric power utilization abnormality monitoring method of an embodiment of the invention.

In FIG. 1, the mobile devices 110_1 to 110_3 include reminder devices 112_1 to 112_3 respectively. The reminder devices 112_1 to 112_3 are, for example, displays adopting liquid-crystal displays (LCDs), light-emitting diodes (LEDs), field-emission displays (FEDs), or other types of panels. The reminder devices 112_1 to 112_3 may be used as a user interface (UI) to display a notification screen (containing a message or a window) to deliver a message or any information to the user. However, in another embodiment, the notification device 130 may also be a speaker that may play a sound to deliver a message to the user, and the invention is not limited thereto.

It should be noted that although the present embodiment is described as having the electric power utilization abnormality monitoring system 100 containing the three mobile devices 110_1 to 110_3, the number of the above mobile devices is not used to limit the invention. Those skilled in the art may extrapolate the number of mobile devices to less or more depending on their actual needs and with reference to the teachings of the present embodiment.

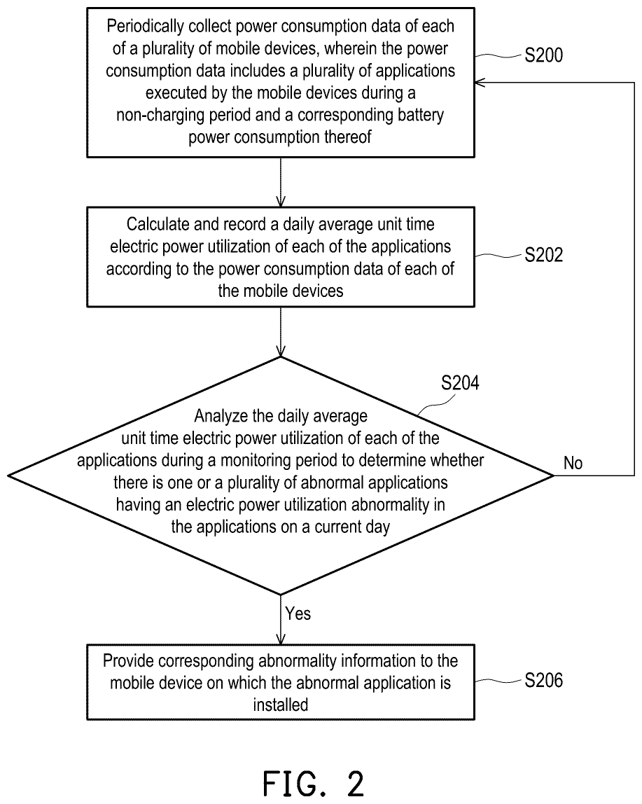

Please refer to FIG. 1 and FIG. 2 at the same time. The electric power utilization abnormality monitoring method of the present embodiment may be applied to the electric power utilization abnormality monitoring system 100 of FIG. 1. Each step of the electric power utilization abnormality monitoring method of the present embodiment is described below with each element in the electric power utilization abnormality monitoring system 100.

First, in step S200, the processor 123 periodically collects power consumption data Pdata1 to Pdata3 of each of the mobile devices 110_1 to 110_3 via the connection device 121. Each of the power consumption data Pdata1 to Pdata3 includes application programs APP1 to APPN (N is a positive integer greater than 1) executed by the corresponding mobile devices 110_1 to 110_3 during the non-charging period and the corresponding battery power consumption thereof. In the present embodiment, the non-charging period refers to the period when the batteries in the mobile devices 110_1 to 110_3 are not charged (which may also be regarded as the period when the batteries are powered). For example, each of the mobile devices 110_1 to 110_3 may periodically (for example, twice a day) aggregate the applications APP1 to APPN executed during the non-charging period and the corresponding battery power consumption, and contain the result in the power consumption data Pdata1 to Pdata3 to be uploaded to the electronic device 120. These power consumption data Pdata1 to Pdata3 need to be collected for a long time and come from different mobile devices and users, so the amount of data is quite large. The processor 123 may properly store the power consumption data Pdata1 to Pdata3 collected each time in the memory 122. It should be noted that although the applications APP1 to APPN are shown in each of the mobile device 110_1 to 110_3 of FIG. 1, this does not mean that each of the mobile devices 110_1 to 110_3 needs to execute all of the applications APP1 to APPN. In an embodiment, the applications executed on each of the mobile devices 110_1 to 110_3 are a portion of the applications APP1 to APPN, and the number of executed applications may also be different.

Next, in step S202, the processor 123 calculates and records the daily average unit time electric power utilization of each of the applications APP1 to APPN executed by the mobile devices 110_1 to 110_3 according to the power consumption data Pdata1 to Pdata3 of each of the mobile devices 110_1 to 110_3. Specifically, the processor 123 may analyze the daily collected power consumption data Pdata1 to Pdata3 to summarize the daily battery power consumption used by each of the applications APP1 to APPN, then calculate the daily average unit time electric power utilization of each of the applications APP1 to APPN accordingly (the daily battery power consumption is divided by the unit time (hour), the unit is, for example, milliamp hours), and record the result in the memory 122.

Next, in step S204, the processor 123 analyzes the daily average unit time electric power utilization of each of the applications APP1 to APPN during the monitoring period to determine whether there is one or a plurality of abnormal applications having electric power utilization abnormality in the applications APP1 to APPN on the current day.

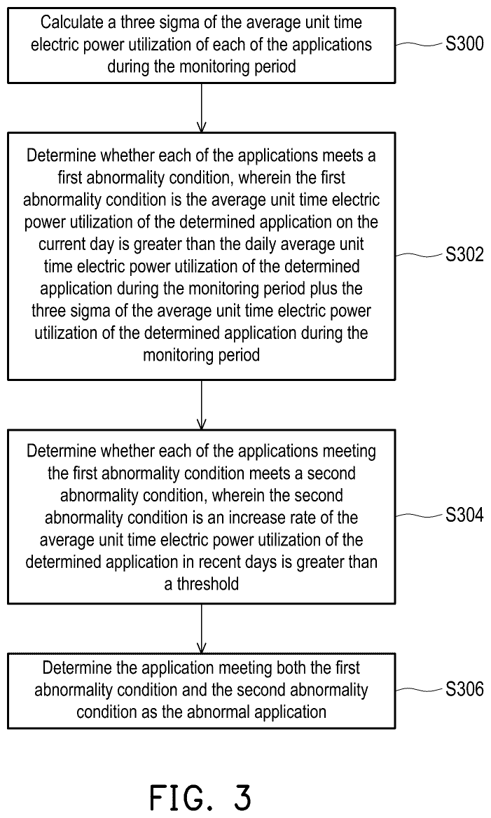

The implementation details of step S204 are as provided for steps S300 to S306 in FIG. 3. First, in step S300, the processor 123 calculates the three sigma of the average unit time electric power utilization of each of the applications APP1 to APPN within the monitoring period. The monitoring period is, for example, 50 days from the current day forward.

Next, in step S302, the processor 123 determines whether each of the applications APP1 to APPN meets a first abnormality condition. The first abnormality condition of the present embodiment is that when determining an application APPK in the applications APP1 to APPN (K is any positive integer from 1 to N), the average unit time electric power utilization of the application APPK on the current day is greater than the average unit time electric power utilization of the application APPK during the monitoring period (for example, 50 days from the current day forward) excluding the current day plus the three sigma of the average unit time electric power utilization of the application APPK during the monitoring period. In short, the processor 123 respectively compares the average unit time electric power utilization of the application APPK on the current day and the daily average unit time electric power utilization of the application APPK in the 50 days from the current day forward, excluding the current day, plus the three sigma thereof. When the average unit time electric power utilization of the application APPK on the current day is greater than the average unit time electric power utilization on any day other than the current day in the 50 days from the current day forward plus the three sigma thereof, the application APPK meets the first abnormality condition.

Next, in step S304, the processor 123 determines whether each of the applications APP1 to APPN meeting the first abnormality condition meets a second abnormality condition. The second abnormality condition of the present embodiment is that when determining an application APPJ (J is any positive integer from 1 to N) in the applications APP1 to APPN meeting the first abnormality condition, the increase rate of the average unit time electric power utilization of the application APPJ in recent days is greater than a threshold. For example, the processor 123 may calculate the increase rate of the average unit time electric power utilization of the application APPJ in the past three days according to the average unit time electric power utilization of the application APPJ for the past three days from the current day forward, and the calculated increase rate is compared with a preset threshold to avoid numerical jitter affecting the determination. When the increase rate of the average unit time electric power utilization of the application APPJ in the past three days is greater than the threshold, the application APPJ meets the second abnormality condition.

Lastly, in step S306, the processor 123 determines the applications APP1 to APPN meeting both the first abnormality condition and the second abnormality condition as the abnormal application.

Please return to FIG. 2. When the processor 123 determines in step S204 that there are no abnormal applications having electric power utilization abnormality in the applications APP1 to APPN on the current day, step S200 is repeated to continue collecting the power consumption data Pdata1 to Pdata3.

When the processor 123 determines in step S204 that there is an abnormal application having electric power utilization abnormality in the applications APP1 to APN on the current day, the processor 123 provides the corresponding abnormality information Iab via the connection device 121 to the mobile device in which the abnormal application is installed in the mobile devices 110_1 to 110_3.

For example, the abnormality information Iab includes an abnormality list. Table 1 below describes an example of the structure of the abnormality list when the applications APP1 and APP3 are determined to be the abnormal applications.

TABLE 1

| | Main | | Power |
|---|---|---|---|
| Abnormal | abnormal | Abnormality | consumption |
| application | version | threshold | factor |
| APP1 (com.kgi) | 122 | 318.12 | CPU |
| APP3 (grasea.familife) | 626 | 343.16 | CPU |

As shown in Table 1, the provided abnormality list includes, for example, the main abnormal version, the abnormality threshold, and the power consumption factor of the abnormal applications. Specifically, the power consumption data Pdata1 to Pdata3 collected by the processor 123 from the mobile devices 110_1 to 110_3 may also include version information of each of the applications APP1 to APPN. That is, which version the applications APP1 to APPN executed by each of the mobile devices 110_1 to 110_3 during the non-charging period is updated to is also recorded in the power consumption data Pdata1 to Pdata3. Since the versions of the applications APP1 to APPN executed by each of the mobile devices 110_1 to 110_3 may be different, even in the power consumption data Pdata1 to Pdata3 collected by the processor 123 on the same day, there may also be related power consumption information (such as battery power consumption) of a plurality of versions for the same application.

When the processor 123 determines that there are abnormal applications having electric power utilization abnormality in the applications APP1 to APPN on the current day, the processor 123 may sequentially select all of the versions of each of the abnormal applications executed on the current day, and calculate the electric power utilization impact of each of the versions by deducting the battery power consumption corresponding to the selected version from the total battery power consumption of the abnormal application on the current day. For example, if the application APP1 is determined to be the abnormal application on the current day, and the versions of the application APP1 executed on the mobile devices 110_1 to 110_3 on the current day are version 1 and version 2, the processor 123 may subtract the battery power consumption corresponding to only version 1 of the application APP1 on the current day (the battery power consumption caused by the application APP1 of version 1) from the total battery power consumption of the application APP1 on the current day, then divide the result by the unit time as the electric power utilization impact of version 1 (the unit is, for example, milliamp hours). Next, the processor 123 may subtract the battery power consumption corresponding to only version 2 of the application APP1 on the current day (the battery power consumption caused by the application APP1 of version 2) from the total battery power consumption of the application APP1 on the current day, then divide the result by the unit time as the electric power utilization impact of version 2, and so on.

The processor 123 may calculate the power consumption impact degree and the statistical test value of each of the versions of each of the abnormal applications executed on the current day according to the average unit time electric power utilization of each of the abnormal applications on the current day in the applications APP1 to APPN and the electric power utilization impact of each of the versions executed on the current day. For example, if the application APP1 is determined to be the abnormal application on the current day, the processor 123 may substitute the average unit time electric power utilization of the application APP1 on the current day and the electric power utilization impact of each of the versions executed on the current day for each of the versions of the application APP1 executed on the current day into the following Formula 1:

$$IRv = ( AVD - IMP ) / AVD * 100 \% \qquad Formula 1$$

wherein IRv is the power consumption impact degree of a certain version of the application APP1, AVD is the average unit time electric power utilization on the current day of the application APP1, and IMP is the electric power utilization impact of a certain version of the application APP1. When IMP is the electric power utilization impact of version 1 of the application APP1, IRv is the power consumption impact degree of version 1. When IMP is the electric power utilization impact of version 2 of the application APP1, IRv is the power consumption impact degree of version 2. In the present embodiment, the processor 123 may record the version of the application APP1 for which the power consumption impact degree is positive as an abnormal version in the abnormality list. The abnormal version having the largest power consumption impact degree may be used as the main abnormal version as shown in Table 1.

In addition, since the versions of all of the applications APP1 to APPN are installed in different quantities on all of the mobile devices 110_1 to 110_3, the processor 123 may also divide the battery power consumption caused by each of the abnormal versions of each of the abnormal applications on the current day by the unit time as the average unit time electric power utilization of each of the abnormal versions on the current day. In addition, the processor 123 may determine whether the average unit time electric power utilization of each of the abnormal versions on the current day exceeds three sigma, and calculate a statistical test value accordingly.

The statistical test value of the present embodiment ensures sufficient confidence via statistical hypothesis testing. For example, the processor 123 may calculate the statistical test value using the following Formula 2:

$$Z = ( \overline{x} - μ ) / ( σ / √ n ) \qquad Formula 2$$

wherein Z is the statistical test value, k is the sample mean, μ is the mean of the parent, a is the standard deviation of the parent, and <n is the root of the number of samples.

Accordingly, the processor 123 may sort the battery power consumption of all of the versions of each of the abnormal applications in the applications APP1 to APPN executed on the current day according to the calculated power consumption impact decree and the statistical test value so as to contain the sorting result and the abnormal version of the electric power utilization abnormality in the abnormality information Jab.

Regarding the abnormality thresholds shown in Table 1 (units are e.g. milliamp hours), the processor 123 may formulate an abnormality threshold applicable to the main abnormal version according to the average unit time electric power utilization or the battery power consumption of the main abnormal version of each of the abnormal applications on the current day. The mobile devices 110_1 to 110_3 receiving the abnormality information Iab may use the abnormality threshold as a criterion for determining whether to update the currently installed application.

Regarding the power consumption factor shown in Table 1, the power consumption data Pdata1 to Pdata3 collected by the processor 123 from the mobile devices 110_1 to 110_3 may also include a plurality of system elements related to the applications APP1 to APPN within each of the mobile devices 110_1 to 110_3 (containing but not limited to: a related element such as mobile network, wireless network, CPU, and Bluetooth) and the corresponding battery power consumption thereof. When the processor 123 determines that there are abnormal applications having electric power utilization abnormality in the applications APP1 to APPN on the current day, the processor 123 may analyze the electric power utilization trend of each of the system elements during the monitoring period to find out the power consumption factor related to the abnormal applications, and contain the power consumption factor in the abnormality information Iab.

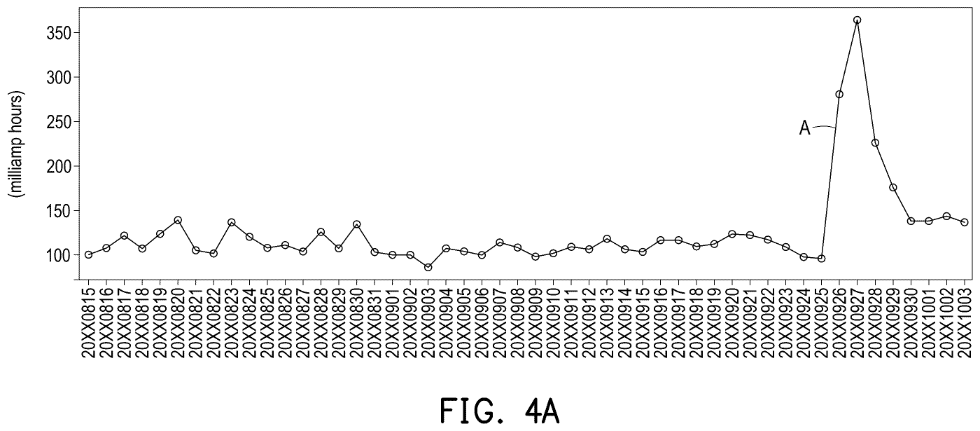

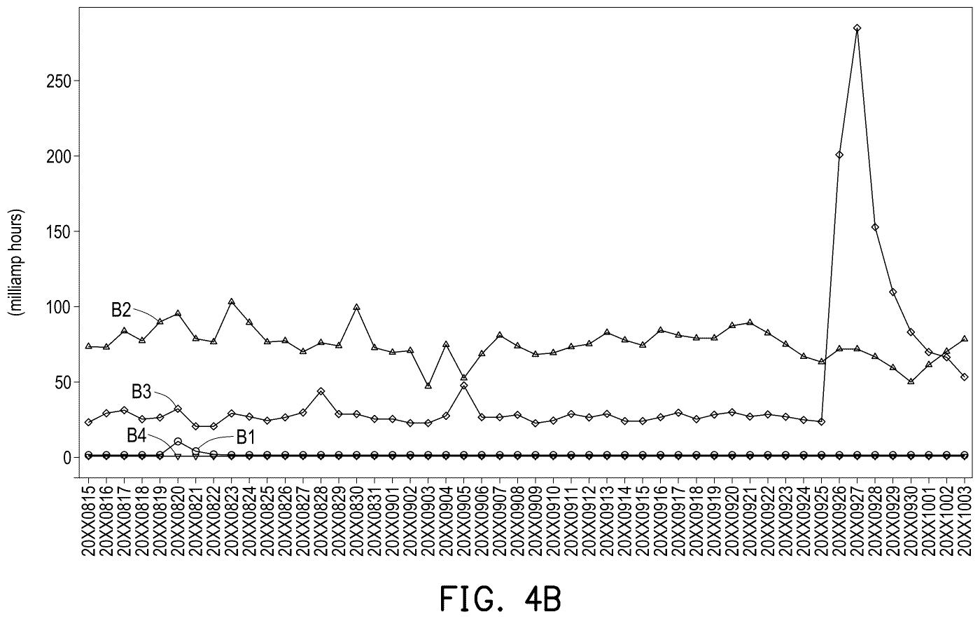

The following description takes the case where the application APP1 is an abnormal application as an example. Please refer to FIG. 4A and FIG. 4B. The horizontal axis of FIG. 4A and FIG. 4B is the date, and the vertical axis of FIG. 4A is the average unit time electric power utilization (unit: milliamp hours) of the application APP1. The vertical axis of FIG. 4B is the average unit time electric power utilization (unit: milliamp hours) of a system element within a mobile device (e.g., the mobile device 110_1).

In FIG. 4A, a curve A composed of the daily average unit time electric power utilization of the application APP1 during the period from August 15, 20XX to October 3, 20XX is shown. In FIG. 4B, curves B1 to B4 composed of the daily average unit time electric power utilization of a mobile network, a wireless network, a CPU, and a Bluetooth device during the period from August 15, 20XX to October 3, 20XX is shown. In order to distinguish the curves B1 to B4, the connection point of the curve B1 representing the mobile network is a circle, the connection point of the curve B2 representing the wireless network is an equilateral triangle, the connection point of the curve B3 representing the CPU is a rhombus, and the connection point of the curve B4 representing the Bluetooth device is an inverted triangle.

As shown in FIG. 4A, the curve A formed by the daily average unit time electric power utilization of the application APP1 on September 26, 20XX has a sharp upward trend. The average unit time electric power utilization of the application APP1 on the current day of September 26, 20XX is greater than the average unit time electric power utilization on any day from the current day forward plus the three sigma thereof, and the increase rate of the average unit time electric power utilization in the past three days is also greater than the threshold. In this case, the application APP1 is determined as an abnormal application.

Observing the curve A and the curves B1 to B4 in FIG. 4A and FIG. 4B at the same time, it is seen that the curve B3 composed of the average unit time electric power utilization of the CPU on September 26, 20XX also has a sharp upward trend. Therefore, the processor 123 may determine that the electric power utilization trend of the application APP1 on September 26, 20XX is positively related to the electric power utilization of the CPU, the main abnormal version of the application APP1 on September 26, 20XX may be associated with the CPU to form a key indicator of electric power utilization abnormality, and the CPU may be recorded in the abnormality list as a power consumption factor.

In an embodiment, when the mobile device 110_1 is installed with the application APP1 as the abnormal application, the mobile device 110_1 receives the abnormality information Jab from the electronic device 120. At this time, the reminder device 112_1 on the mobile device 110_1 may perform a reminder operation related to the application APP1 according to the abnormality information Jab.

Specifically, the abnormality information Jab includes an abnormality list updated by the electronic device 120 and containing the main abnormal version, the abnormality threshold, and the power consumption factor of the application APP1. The mobile device 110_1 may update the abnormality list currently stored in the device itself according to the received abnormality information Jab. In this way, when the user installs the main abnormal version of the application APP1 on the mobile device 110_1, and when it is detected that the battery power consumption of the application APP1 reaches the abnormality threshold defined in the abnormality list or the power consumption of the corresponding system element (such as a mobile network, a wireless network, a CPU, or a Bluetooth device) also reaches the threshold, the reminder device 1121 may display a notification screen (containing a message or a window) to remind the user that the version of the application APP1 currently installed on the mobile device 110_1 has electric power utilization abnormality, so as to recommend the user to install other less power-consuming versions or formulate the corresponding power-saving strategy for the corresponding system element. For example, for a mobile network and a wireless network, a power-saving strategy of limiting the network traffic that the application APP1 may transmit every day may be set or a network traffic reminder may be set. For a Bluetooth device, a power-saving strategy of the application APP1 directly closing the Bluetooth connection in the background state may be set. Another example is a power-saving strategy for the CPU allowing the system to limit the survival time of the application APP1 in the background state.

Based on the above, the electric power utilization abnormality monitoring method and system of the invention may analyze power consumption data related to applications and system elements uploaded by each of the mobile devices to accurately detect the applications and the versions thereof causing electric power utilization abnormality on the current day. Also, system elements that are power consuming factors may be identified. In this way, the user may detect the electric power utilization abnormality as early as possible and adopt a corresponding power-saving strategy, and the power-saving strategy may be made more accurate and flexible.

What is claimed is:

1. An electric power utilization abnormality monitoring method, comprising the following steps:
periodically collecting power consumption data of each of a plurality of mobile devices, wherein the power consumption data comprises a plurality of applications executed by the mobile devices during a non-charging period and a corresponding battery power consumption thereof;
calculating and recording a daily average unit time electric power utilization of each of the applications according to the power consumption data of each of the mobile devices;
analyzing the daily average unit time electric power utilization of each of the applications during a monitoring period to determine whether there is one or a plurality of abnormal applications having an electric power utilization abnormality in the applications on a current day; and
providing corresponding abnormality information to the mobile devices on which the one or plurality of abnormal applications are installed when the one or plurality of abnormal applications exist.

2. The electric power abnormality monitoring method of claim 1, wherein the step of analyzing the daily average unit time electric power utilization of each of the applications during the monitoring period to determine whether there is the one or plurality of abnormal applications having the electric power utilization abnormality in the applications on the current day comprises:
calculating a three sigma of the average unit time electric power utilization of each of the applications during the monitoring period;
determining whether each of the applications meets a first abnormality condition, wherein the first abnormality condition is the average unit time electric power utilization of the determined application on the current day is greater than the daily average unit time electric power utilization of the determined application during the monitoring period excluding the current day plus the three sigma of the average unit time electric power utilization of the determined application during the monitoring period;
determining whether each of the applications meeting the first abnormality condition meets a second abnormality condition, wherein the second abnormality condition is an increase rate of the average unit time electric power utilization of the determined application in recent days is greater than a threshold; and
determining the one or plurality of applications meeting both the first abnormality condition and the second abnormality condition as the one or plurality of abnormal applications.

3. The electric power utilization abnormality monitoring method of claim 1, wherein the power consumption data further comprises version information of each of the applications, and the electric power utilization abnormality monitoring method further comprises:
selecting all versions of each of the one or plurality of abnormal applications executed on the current day sequentially, and calculating an electric power utilization impact of each of the versions by deducting the battery power consumption corresponding to the selected version from a total battery power consumption of each of the one or plurality of abnormal applications on the current day when the one or plurality of abnormal applications exist;
calculating a power consumption impact degree and a statistical test value of each of the versions of each of the one or plurality of abnormal applications executed on the current day according to the average unit time electric power utilization of each of the one or plurality of abnormal applications on the current day and the electric power utilization impact of each of the versions executed on the current day; and
sorting all of the versions of each of the one or plurality of abnormal applications executed on the current day according to the power consumption impact degree and the statistical test value, so as to contain a sorting result and an abnormal version of the electric power utilization abnormality in the abnormality information.

4. The electric power utilization monitoring method of claim 3, wherein the step of calculating the electric power utilization impact of each of the versions by deducting the battery power consumption corresponding to the selected version from the total battery power consumption of each of the one or plurality of abnormal applications on the current day comprises:
subtracting the battery power consumption corresponding to only the selected version of the abnormal application on the current day from the total battery power consumption of the abnormal application on the current day, then dividing the result by a unit time as the electric power utilization impact of the selected version.

5. The electric power utilization monitoring method of claim 1, wherein the power consumption data further comprises a plurality of system elements related to the applications within each of the mobile devices and a corresponding battery power consumption thereof, and the electric power utilization abnormality monitoring method further comprises:
analyzing an electric power utilization trend of each of the system elements during the monitoring period to find a power consumption factor related to the one or plurality of abnormal applications, and containing the power consumption factor in the abnormality information when the one or plurality of abnormal applications exist.

6. The electric power utilization monitoring method of claim 1, further comprising:
performing a reminder operation according to the abnormality information on the mobile devices on which the one or plurality of abnormal applications are installed.

7. An electric power utilization abnormality monitoring system, comprising:
a plurality of mobile devices; and
an electronic device, comprising:
a connection device configured to be connected to the mobile devices;
a memory configured to store data; and
a processor coupled to the connection device and the memory and configured to:
collect power consumption data of each of the mobile devices periodically via the connection device, wherein the power consumption data comprises a plurality of applications executed by the mobile devices during a non-charging period and a corresponding battery power consumption thereof;
calculate and record a daily average unit time electric power utilization of each of the applications according to the power consumption data of each of the mobile devices;
analyze the daily average unit time electric power utilization of each of the applications during a monitoring period to determine whether there is one or a plurality of abnormal applications having an electric power utilization abnormality in the applications on a current day; and
provide corresponding abnormality information to the mobile devices on which the one or plurality of abnormal applications are installed via the connection device when the one or plurality of abnormal applications exist.

8. The electric power utilization abnormality monitoring system of claim 7, wherein the processor calculates a three sigma of the average unit time electric power utilization of each of the applications during the monitoring period,
the processor determines whether each of the applications meets a first abnormality condition, wherein the first abnormality condition is the average unit time electric power utilization of the determined application on the current day is greater than the average unit time electric power utilization of the determined application during the monitoring period excluding the current day plus the three sigma of the average unit time electric power utilization of the determined application during the monitoring period,
the processor determines whether each of the applications meeting the first abnormality condition meets a second abnormality condition, wherein the second abnormality condition is an increase rate of the average unit time electric power utilization of the determined application in recent days is greater than a threshold,
the processor determines the one or plurality of applications meeting both the first abnormality condition and the second abnormality condition as the one or plurality of abnormal applications.

9. The electric power utilization abnormality monitoring system of claim 7, wherein the power consumption data further comprises version information of each of the applications, and when the one or plurality of abnormal applications exist, all versions of each of the one or plurality of abnormal applications executed on the current day are selected sequentially, and an electric power utilization impact of each of the versions is calculated by deducting the battery power consumption corresponding to a selected version from a total battery power consumption of each of the one or plurality of abnormal applications on the current day,
the processor calculates a power consumption impact degree and a statistical test value of each of the versions of each of the one or plurality of abnormal applications executed on the current day according to the average unit time electric power utilization of each of the one or plurality of abnormal applications on the current day and the electric power utilization impact of each of the versions executed on the current day,
the processor sorts all of the versions of each of the one or plurality of abnormal applications executed on the current day according to the power consumption impact degree and the statistical test value, so as to contain a sorting result and an abnormal version of the electric power utilization abnormality in the abnormality information.

10. The electric power utilization abnormality monitoring system of claim 9, wherein the processor subtracts the battery power consumption corresponding to only the selected version of the abnormal application on the current day from the total battery power consumption of the abnormal application on the current day, then divides the result by a unit time as the electric power utilization impact of the selected version.

11. The electric power utilization abnormality monitoring system of claim 7, wherein the power consumption data further comprises a plurality of system elements related to the applications within each of the mobile devices and a corresponding battery power consumption thereof, and when the one or plurality of abnormal applications exist, the processor analyzes an electric power utilization trend of each of the system elements during the monitoring period to find a power consumption factor related to the one or plurality of abnormal applications, and contains the power consumption factor in the abnormality information.

12. The electric power utilization abnormality monitoring system of claim 7, wherein each of the mobile devices comprises a reminder device,
the corresponding reminder device performs a reminder operation according to the abnormality information on the mobile devices on which the one or plurality of abnormal applications are installed.
